(19) United States
(12) Patent Application Publication
(10) Pub. No.: US 2025/0387888 A1
(43) Pub. Date: Dec. 25, 2025

(54) ELECTRONIC TORQUE WRENCH WITH TORQUE OVERSHOOT COMPENSATION

(71) Applicant: Apex Brands, Inc., Apex, NC (US)

(72) Inventors: Bin Sun, Shanghai (CN); Henglian Luo, Shanghai (CN); Tong Li, Shanghai (CN)

(21) Appl. No.: 18/880,560

(22) PCT Filed: Jul. 1, 2022
(86) PCT No.: PCT/CN2022/103234

§ 371 Date: Jan. 1, 2025

(51) Int. Cl. B25B 23/142

(52) U.S. Cl. CPC B25B 23/1425

(57) ABSTRACT

An apparatus such as an electronic torque wrench (100) includes processing circuitry (202) and one or more transducers (210). The processing circuitry (202) is configured to determine the applied torque (404), and determine an indication torque that is less than a target torque by an estimated torque overshoot representing an added amount over the applied torque for an estimated response time of an operator (406). The processing circuitry (202) is configured to compare the applied torque and the indication torque to determine when the applied torque matches the indication torque (408); and in response, output an alert to the operator to release a force from which the applied torque is produced (410). The alert is output as an output signal, and the one or more transducers (210) are configured to convert the output signal to user-perceptible feedback.

### TECHNOLOGICAL FIELD

The present disclosure relates generally to torque application and measurement devices and, in particular, to an apparatus for torque measurement such as an electronic torque wrench.

### BACKGROUND

Fasteners are often used to assemble performance critical components are tightened to a specified torque level to introduce a “pretension” in the fastener. As torque is applied to the head of the fastener, the fastener may begin to stretch beyond a certain level of applied torque. This stretch results in the pretension in the fastener which then holds the components together. Additionally, it is often necessary to further rotate the fastener through a specified angle after the desired torque level has been applied. A popular method of tightening these fasteners is to use a torque wrench.

Torque wrenches may be of mechanical or electronic type. Mechanical torque wrenches are generally less expensive than electronic. There are two common types of mechanical torque wrenches, beam and clicker types. In a beam type torque wrench, a beam bends relative to a non-deflecting beam in response to applied torque. The amount of deflection of the bending beam relative to the non-deflecting beam indicates the amount of torque applied to the fastener. Clicker type torque wrenches have a selectable preloaded snap mechanism with a spring to release at a specified, target torque, thereby generating a click noise to alert the operator to release force on the wrench from which the applied torque is produced.

Electronic torque wrenches tend to be more expensive than mechanical torque wrenches. Many electronic torque wrenches include a user interface with a human input device and an electronic visual display. The electronic torque wrench may receive a target torque through its user interface; and when applying torque to a fastener with an electronic torque wrench, torque readings may be indicated on the electronic visual display that relate to the pretension in the fastener due to the applied torque. The electronic torque wrench may also alert the operator to release the force on the wrench when the applied torque reaches the target torque.

Although torque wrenches alert the operator to release the force on the wrench when the applied torque reaches the target torque, the time it takes the operator to respond to the alert often leads to an added amount over the applied torque and thereby the target torque. It would therefore be desirable to have a system and method that addresses this issue, as well as other possible issues.

### BRIEF SUMMARY

Example implementations of the present disclosure are directed to an apparatus such as an electronic torque wrench for torque measurement with torque overshoot compensation. The present disclosure includes, without limitation, the following example implementations.

Some example implementations provide an apparatus operable to determine an applied torque, the apparatus comprising: processing circuitry configured to at least: receive an indication of a target torque; determine the applied torque; determine an indication torque that is less than the target torque by an estimated torque overshoot representing an added amount over the applied torque for an estimated response time of an operator; compare the applied torque and the indication torque to determine when the applied torque matches the indication torque; and in response, output an alert to the operator to release a force from which the applied torque is produced; and one or more transducers operably coupled to the processing circuitry, the alert output as an output signal, and the one or more transducers configured to convert the output signal to user-perceptible feedback.

Some example implementations provide a method of operating an apparatus to determine an applied torque, the method comprising: receiving an indication of a target torque; determining the applied torque; determining an indication torque that is less than the target torque by an estimated torque overshoot representing an added amount over the applied torque for an estimated response time of an operator; comparing the applied torque and the indication torque to determine when the applied torque matches the indication torque; and in response, outputting an alert to the operator to release a force from which the applied torque is produced.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIGS. 1A and 1B illustrate an electronic torque wrench, according to some example implementations of the present disclosure;

FIG. 2 is a block diagram of an apparatus for determining an applied torque, and that may correspond to the electronic torque wrench of FIG. 1, according to some example implementations;

FIG. 3 is a graph of applied torque over time for an operation of an apparatus such as an electronic torque wrench, according to example implementations; and

FIGS. 4A, 4B, 4C, 4D, 4E and 4F are flowcharts illustrating various steps in a method of operating an apparatus such as an electronic torque wrench to determine an applied torque, according to various example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably.

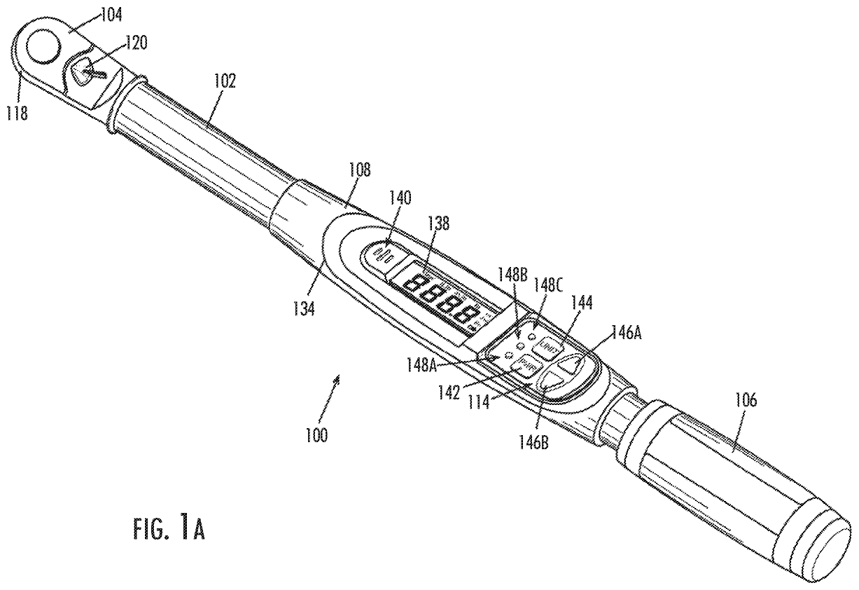

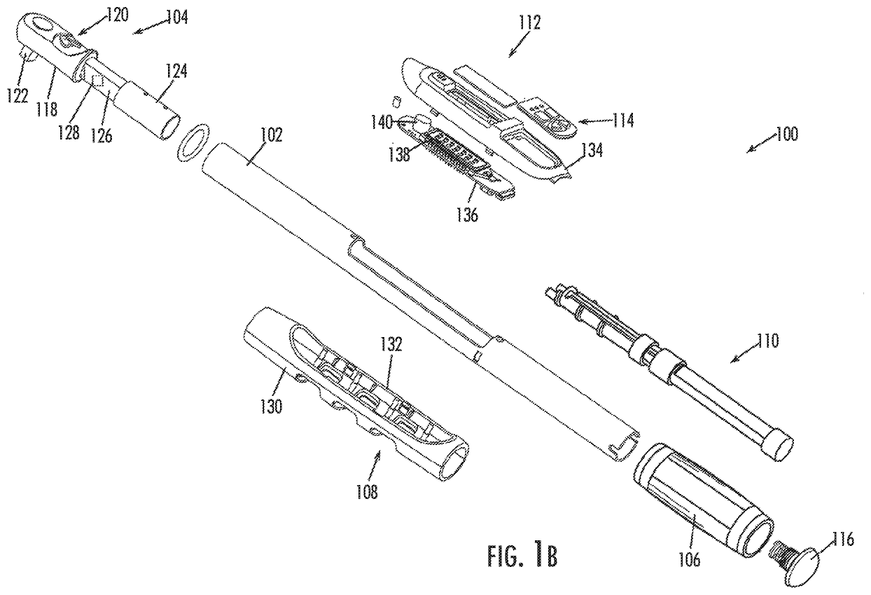

Example implementations of the present disclosure relate generally to torque application and measurement devices. Example implementations will primarily be described in the context of an electronic torque wrench. Other examples of suitable apparatuses for torque measurement include a torque tester, torque meter, torque transducer or the like. FIGS. 1A and 1B illustrate an electronic torque wrench 100 according to some example implementations of the present disclosure. As shown, the electronic torque wrench includes a wrench body 102, a wrench head 104 (e.g., a ratcheting wrench head), a grip handle 106, a housing 108, a battery assembly 110, and an electronics unit 112 with a user interface 114. In some examples, the wrench body is of tubular construction, made of steel or other rigid material, and receives the wrench head at a first end and the battery assembly at a second end, secured therein by an end cap 116. In some of these examples, the housing is mounted therebetween and carries the electronics unit.

As shown, a front end 118 of the wrench head 104 includes a coupler with a lever 120 that allows a user to select whether torque is applied to a fastener in either a clockwise (CW) or counter-clockwise (CCW) direction. The front end also includes a boss 122 for receiving variously sized sockets, extensions, etc. A rear end 124 of the wrench head is slidably received in the wrench body 102 and rigidly secured therein. The wrench head includes at least one vertical flat portion 126 formed between the front end and the rear end for receiving a strain gauge assembly 128. The flat portion of the wrench head is both transverse to the plane of rotation of torque wrench 100 and parallel to the longitudinal center axis of the wrench head. The strain gauge assembly includes one or more strain gauges. In some examples, the strain gauge assembly is a full-bridge assembly including four separate strain gauges on a single film that is secured to the flat portion of the wrench head. Together, the full-bridge strain gauge assembly mounted on the flat portion of the wrench head is referred to as a strain tensor.

As also shown, the housing 108 includes a bottom portion 130 that is slidably received about the wrench body 104 and defines an aperture 132 for receiving a top portion 134 that carries the electronics unit 112. The electronics unit provides the user interface 114 for the operation of the electronic torque wrench 100. The electronics unit includes a circuit board 136 including a digital display 138 and an annunciator 140 mounted thereon. The portion of the housing defines an aperture that receives the user interface, which includes a power button 142, a unit selection button 144, increment/decrement buttons 146A and 146B, and three light emitting diodes (LEDs) 148A, 148B and 148C. And the LEDs may illuminate green, yellow and red, respectively, when activated.

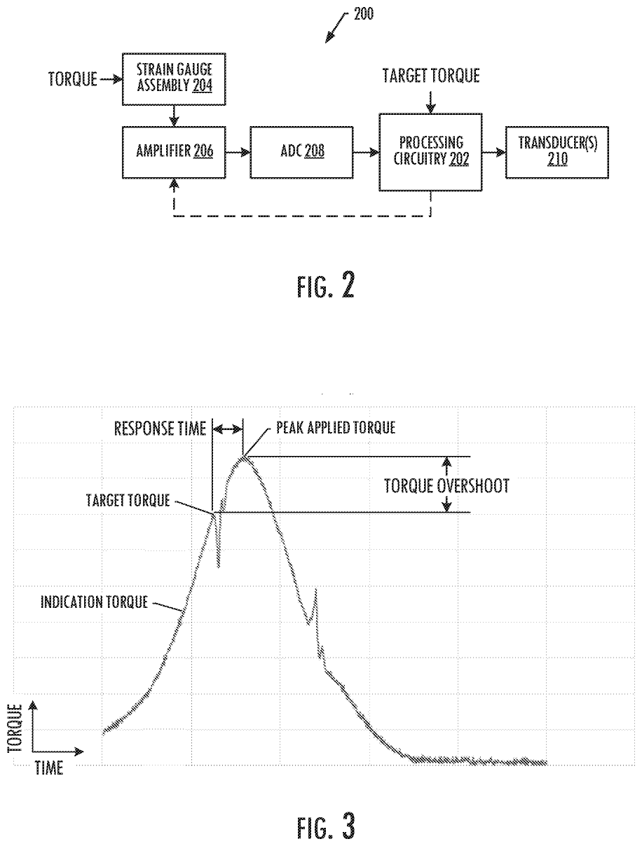

FIG. 2 illustrates an apparatus 200 for determining a torque value of an applied torque, according to some example implementations. The apparatus may be embodied in a number of different manners, and in some examples, the apparatus is an electronic torque wrench such as electronic torque wrench 100. In other examples, the apparatus is a torque tester, torque meter, torque transducer or the like. The apparatus includes one or more of a number of components that are operably coupled to one another. As shown, for example, the apparatus includes one or more of processing circuitry 202, a strain gauge assembly 204 (e.g., strain gauge assembly 128), an amplifier 206, an analog-to-digital converter (ADC) 208, one or more transducers 210 (e.g., digital display 138, annunciator 140, LEDs 148A, 148B and 148C), or the like. In some examples in which the apparatus corresponds to electronic torque wrench 100, one or more of the components may be components of the electronics unit 112, perhaps carried by the circuit board 136.

The processing circuitry 202 is configured to determine an applied torque such as the torque applied to a fastener when the apparatus 200 is an electronic torque wrench, and compare the applied torque to a target torque that may be received via a user interface of the apparatus 200 (e.g., user interface 114). In some examples, this includes the strain gauge assembly 204 configured to measure the applied torque, and produce an analog electrical signal that varies in voltage with the applied torque. In some examples, the apparatus includes the amplifier 206 configured to receive the analog electrical signal, and increase an amplitude of the analog electrical signal to produce an amplified analog electrical signal. The ADC 208 is configured to convert the (amplified) analog electrical signal to an equivalent digital electrical signal. The processing circuitry, then, is configured to determine the applied torque from the equivalent digital electrical signal. In some more particular examples, the equivalent digital electrical signal includes digital data points. In some of these examples, the processing circuitry is configured to determine a subset of the digital data points in a moving sample window, and calculate the applied torque from a rolling average of the subset of the digital data points in the moving sample window.

To further illustrate use of the rolling average, consider an example in which the processing circuitry 202 samples one thousand digital data points per second and uses a moving sample window of ten milliseconds. As torque is applied, the processing circuitry may average the first ten digital data points, one taken each millisecond, thereby producing a first equivalent digital value at time t=0.01 seconds, wherein t=0.0 seconds marks initiation of the torquing operation. At time t=0.011 seconds, the processing circuitry may average the digital data points taken between times t=0.002 and t=0.011 seconds, thereby producing a second equivalent digital value. At time t=0.012 seconds, the processing circuitry may average the digital data points taken between times t=0.003 seconds and t=0.012 seconds, thereby producing a third equivalent digital value. And this may continue such that an equivalent digital value may be provided every millisecond until the torque is no longer applied. In short, the processing circuitry may utilize a digital filtering algorithm to provide a rolling average in which the oldest digital data point is dropped each time a new digital data point is received within the moving sample window.

The processing circuitry 202 may be configured to compare the applied torque and the target torque to determine when the applied torque matches the target torque, such as when the applied torque is within a threshold torque of the target torque. In response, the processing circuitry may be configured to output an alert to the operator to release a force from which the applied torque is produced. In some examples, the alert is output as an output signal, and the one or more transducers 210 are configured to convert the output signal to user-perceptible feedback.

In various examples, the one or more transducers 210 include one or more of an electromechanical transducer, an electroacoustic transducer or one or more electro-optical transducers. In this regard, an electromechanical transducer is configured to convert the output signal to haptic feedback. Examples of suitable electromechanical transducers include eccentric rotating mass (ERM) actuators, a linear resonant actuators (LRAs), piezoelectric actuators and the like. An electroacoustic transducer such as a loudspeaker is configured to convert the output signal to audible feedback. An electro-optical transducer is configured to convert the output signal to visual feedback. Examples of suitable electro-optical transducers include light emitting diode (LED) indicators.

As explained in the background section, although torque wrenches alert the operator to release the force on the wrench when the applied torque reaches the target torque, the time it takes the operator to respond to the alert often leads to an added amount over the applied torque and thereby the target torque. FIG. 3 illustrates a graph of applied torque over time, and indicates a torque overshoot over a response time for the case in which an alert is output when the applied torque matches the target torque, yielding (peak) applied torque that is greater than the target torque when force on the wrench is released. According to some example implementations, in addition to or in lieu of an alert when the applied torque matches the target torque, the processing circuitry 202 may be configured to output an earlier alert to compensate for an added amount over the applied torque for an estimated response time of the operator. Given the response time of the operator, then, the applied torque may more closely match the target torque when the force is released.

According to some example implementations, the processing circuitry 202 is configured to determine an indication torque that is less than a target torque by an estimated torque overshoot representing an added amount over the applied torque for an estimated response time of the operator. The processing circuitry is configured to compare the applied torque and the indication torque to determine when the applied torque matches the indication torque (e.g., within a threshold torque of the indication torque). In response, the processing circuitry may output an alert to the operator (via the one or more transducers 210) to release the force from which the applied torque is produced, such as in the same or similar manner as described above.

In some examples, the processing circuitry 202 is configured to determine a time rate of change of the applied torque, and determine the estimated torque overshoot based on the time rate of change of the applied torque, and the estimated response time. In some further examples, the estimated torque overshoot is determined as a product of the time rate of change of the applied torque, and the estimated response time. More notationally, the processing circuitry may determine a time rate of change of the applied torque ΔT/Δt, and determine the estimated torque overshoot as (ΔT/Δt)×t_{Response}, where t_{Response} represents the estimated response time. The indication torque may then be determined as T_{Indication}=T_{Target}−(ΔT/Δt)×t_{Response}, where T_{Target} represents the target torque.

In some examples, the estimated response time for an operation of the apparatus 200 may be determined from an actual response time for a previous operation of the apparatus. Likewise, in some examples, the processing circuitry 202 may be further configured to determine an actual response time for the operation as a time between output of the alert and release of the force by the operator. The processing circuitry may be configured to then determine the estimated response time for a next operation of the apparatus from the actual response time.

The processing circuitry 202 of example implementations of the present disclosure may be composed of one or more processors alone or in combination with one or more memories. The processing circuitry is generally any piece of computer hardware that is capable of processing information such as, for example, data, computer programs and/or other suitable electronic information. The processing circuitry is composed of a collection of electronic circuits some of which may be packaged as an integrated circuit or multiple interconnected integrated circuits (an integrated circuit at times more commonly referred to as a “chip”). In more particular examples, the processing circuitry may be embodied as or include a processor, coprocessor, controller, microprocessor, microcontroller, application specific integrated circuit (ASIC), field programmable gate array (FPGA) or the like.

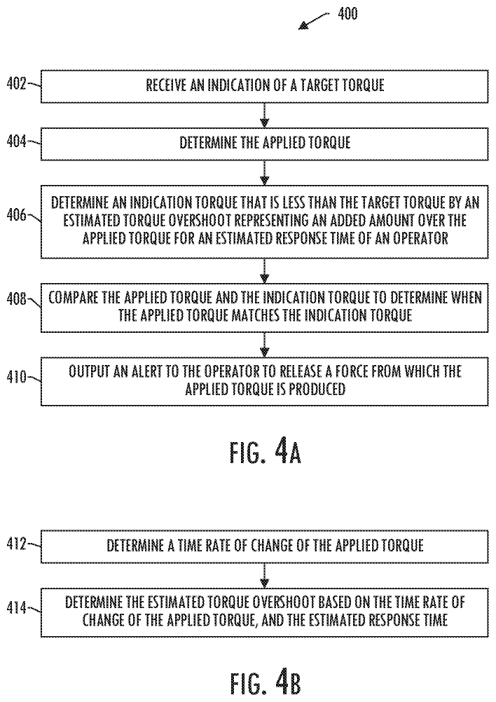

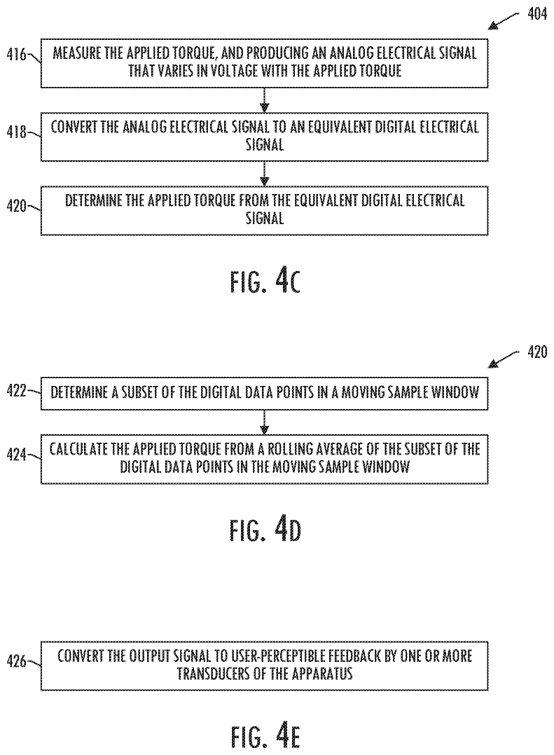

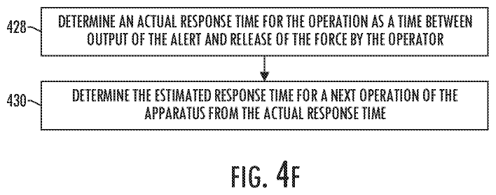

FIGS. 4A-4F are flowcharts illustrating various steps in a method 400 of operating an apparatus to determine an applied torque, according to various example implementations of the present disclosure. The method includes receiving an indication of a target torque, as shown at block 402 of FIG. 4A. The method includes determining the applied torque, as shown at block 404. The method includes determining an indication torque that is less than the target torque by an estimated torque overshoot representing an added amount over the applied torque for an estimated response time of an operator, as shown at block 406. The method includes comparing at block 408 the applied torque and the indication torque to determine when the applied torque matches the indication torque; and in response. outputting at block 410 an alert to the operator to release a force from which the applied torque is produced.

In some examples, the apparatus is embodied as an electronic torque wrench, and the applied torque is a torque applied by the electronic torque wrench to a fastener.

In some examples, the applied torque matches the indication torque when the applied torque is within a threshold torque of the indication torque.

In some examples, the method 400 further includes determining a time rate of change of the applied torque, as shown at block 412 of FIG. 4B. And the method includes determining the estimated torque overshoot based on the time rate of change of the applied torque, and the estimated response time, as shown at block 414.

In some examples, the estimated torque overshoot is determined at block 414 as a product of the time rate of change of the applied torque, and the estimated response time.

In some examples, determining the applied torque at block 404 includes measuring the applied torque, and producing an analog electrical signal that varies in voltage with the applied torque, as shown at block 416 of FIG. 4C. The method 400 includes converting the analog electrical signal to an equivalent digital electrical signal, as shown at block 418. And the method includes determining the applied torque from the equivalent digital electrical signal, as shown at block 420.

In some examples, the equivalent digital electrical signal includes digital data points, and determining the applied torque at block 420 includes determining a subset of the digital data points in a moving sample window, as shown at block 422 of FIG. 4D. And the method 400 includes calculating the applied torque from a rolling average of the subset of the digital data points in the moving sample window, as shown at block 424.

In some examples, the alert is output at block 410 as an output signal. In some of these examples, method 400 further includes converting the output signal to user-perceptible feedback by one or more transducers of the apparatus, as shown at block 426 of FIG. 4E.

In some examples, the one or more transducers include an electromechanical transducer converting the output signal to haptic feedback.

In some examples, the electromechanical transducer includes an eccentric rotating mass (ERM) actuator, a linear resonant actuator (LRA) or a piezoelectric actuator.

In some examples, the one or more transducers include an electroacoustic transducer converting the output signal to audible feedback.

In some examples, the electroacoustic transducer includes a loudspeaker.

In some examples, the one or more transducers include one or more electro-optical transducers converting the output signal to visual feedback, and the one or more electro-optical transducers include one or more light emitting diode (LED) indicators.

In some examples, the method 400 is performed for an operation of the apparatus to determine the applied torque, and the estimated response time is determined from an actual response time for a previous operation of the apparatus.

In some examples, the method 400 is performed for an operation of the apparatus to determine the applied torque, and method further includes determining an actual response time for the operation as a time between output of the alert and release of the force by the operator, as shown at block 428 of FIG. 4F. And the method includes determining the estimated response time for a next operation of the apparatus from the actual response time, as shown at block 430.

As explained above and reiterated below, the present disclosure includes, without limitation, the following example implementations.

Clause 1. An apparatus operable to determine an applied torque, the apparatus comprising: processing circuitry configured to at least: receive an indication of a target torque; determine the applied torque; determine an indication torque that is less than the target torque by an estimated torque overshoot representing an added amount over the applied torque for an estimated response time of an operator; compare the applied torque and the indication torque to determine when the applied torque matches the indication torque; and in response, output an alert to the operator to release a force from which the applied torque is produced; and one or more transducers operably coupled to the processing circuitry, the alert output as an output signal, and the one or more transducers configured to convert the output signal to user-perceptible feedback.

Clause 2. The apparatus of clause 1, wherein the apparatus is embodied as an electronic torque wrench, and the applied torque is a torque applied by the electronic torque wrench to a fastener.

Clause 3. The apparatus of clause 1 or clause 2, wherein the applied torque matches the indication torque when the applied torque is within a threshold torque of the indication torque.

Clause 4. The apparatus of any of clauses 1 to 3, wherein the processing circuitry is further configured to: determine a time rate of change of the applied torque; and determine the estimated torque overshoot based on the time rate of change of the applied torque, and the estimated response time.

Clause 5. The apparatus of clause 4, wherein the estimated torque overshoot is determined as a product of the time rate of change of the applied torque, and the estimated response time.

Clause 6. The apparatus of any of clauses 1 to 5, wherein the apparatus further comprises: a strain gauge assembly configured to measure the applied torque, and produce an analog electrical signal that varies in voltage with the applied torque; and an analog-to-digital converter configured to convert the analog electrical signal to an equivalent digital electrical signal, and wherein the processing circuitry is configured to determine the applied torque from the equivalent digital electrical signal.

Clause 7. The apparatus of clause 6, wherein the equivalent digital electrical signal includes digital data points, and the processing circuitry configured to determine the applied torque includes the processing circuitry configured to: determine a subset of the digital data points in a moving sample window; and calculate the applied torque from a rolling average of the subset of the digital data points in the moving sample window.

Clause 8. The apparatus of any of clauses 1 to 7, wherein the one or more transducers include an electromechanical transducer configured to convert the output signal to haptic feedback.

Clause 9. The apparatus of clause 8, wherein the electromechanical transducer includes an eccentric rotating mass (ERM) actuator, a linear resonant actuator (LRA) or a piezoelectric actuator.

Clause 10. The apparatus of any of clauses 1 to 9, wherein the one or more transducers include an electroacoustic transducer configured to convert the output signal to audible feedback.

Clause 11. The apparatus of clause 10, wherein the electroacoustic transducer includes a loudspeaker.

Clause 12. The apparatus of any of clauses 1 to 11, wherein the one or more transducers include one or more electro-optical transducers configured to convert the output signal to visual feedback, and the one or more electro-optical transducers include one or more light emitting diode (LED) indicators.

Clause 13. The apparatus of any of clauses 1 to 12, wherein the apparatus is operable for an operation to determine the applied torque, and the estimated response time is determined from an actual response time for a previous operation of the apparatus.

Clause 14. The apparatus of any of clauses 1 to 13, wherein the apparatus is operable for an operation to determine the applied torque, and the processing circuitry is further configured to: determine an actual response time for the operation as a time between output of the alert and release of the force by the operator; and determine the estimated response time for a next operation of the apparatus from the actual response time.

Clause 15. A method of operating an apparatus to determine an applied torque, the method comprising: receiving an indication of a target torque; determining the applied torque; determining an indication torque that is less than the target torque by an estimated torque overshoot representing an added amount over the applied torque for an estimated response time of an operator; comparing the applied torque and the indication torque to determine when the applied torque matches the indication torque; and in response, outputting an alert to the operator to release a force from which the applied torque is produced.

Clause 16. The method of clause 15, wherein the apparatus is embodied as an electronic torque wrench, and the applied torque is a torque applied by the electronic torque wrench to a fastener.

Clause 17. The method of clause 15 or clause 16, wherein the applied torque matches the indication torque when the applied torque is within a threshold torque of the indication torque.

Clause 18. The method of any of clauses 15 to 17, wherein the method further comprises: determining a time rate of change of the applied torque; and determining the estimated torque overshoot based on the time rate of change of the applied torque, and the estimated response time.

Clause 19. The method of clause 18, wherein the estimated torque overshoot is determined as a product of the time rate of change of the applied torque, and the estimated response time.

Clause 20. The method of any of clauses 15 to 19, wherein determining the applied torque includes: measuring the applied torque, and producing an analog electrical signal that varies in voltage with the applied torque; converting the analog electrical signal to an equivalent digital electrical signal; and determining the applied torque from the equivalent digital electrical signal.

Clause 21. The method of clause 20, wherein the equivalent digital electrical signal includes digital data points, and determining the applied torque includes: determining a subset of the digital data points in a moving sample window; and calculating the applied torque from a rolling average of the subset of the digital data points in the moving sample window.

Clause 22. The method of any of clauses 15 to 21, wherein the alert is output as an output signal, and the method further comprises converting the output signal to user-perceptible feedback by one or more transducers of the apparatus.

Clause 23. The method of clause 22, wherein the one or more transducers include an electromechanical transducer converting the output signal to haptic feedback.

Clause 24. The method of clause 23, wherein the electromechanical transducer includes an eccentric rotating mass (ERM) actuator, a linear resonant actuator (LRA) or a piezoelectric actuator.

Clause 25. The method of any of clauses 22 to 24, wherein the one or more transducers include an electroacoustic transducer converting the output signal to audible feedback.

Clause 26. The method of clause 25, wherein the electroacoustic transducer includes a loudspeaker.

Clause 27. The method of any of clauses 22 to 26, wherein the one or more transducers include one or more electro-optical transducers converting the output signal to visual feedback, and the one or more electro-optical transducers include one or more light emitting diode (LED) indicators.

Clause 28. The method of any of clauses 15 to 27, wherein the method is performed for an operation of the apparatus to determine the applied torque, and the estimated response time is determined from an actual response time for a previous operation of the apparatus.

Clause 29. The method of any of clauses 15 to 28, wherein the method is performed for an operation of the apparatus to determine the applied torque, and the method further comprises: determining an actual response time for the operation as a time between output of the alert and release of the force by the operator; and determining the estimated response time for a next operation of the apparatus from the actual response time.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus operable to determine an applied torque, the apparatus comprising:
processing circuitry configured to at least:
receive an indication of a target torque;
determine the applied torque;
determine an indication torque that is less than the target torque by an estimated torque overshoot representing an added amount over the applied torque for an estimated response time of an operator;
compare the applied torque and the indication torque to determine when the applied torque matches the indication torque; and in response,
output an alert to the operator to release a force from which the applied torque is produced; and
one or more transducers operably coupled to the processing circuitry, the alert output as an output signal, and the one or more transducers configured to convert the output signal to user-perceptible feedback.

2. The apparatus of claim 1, wherein the apparatus is embodied as an electronic torque wrench, and the applied torque is a torque applied by the electronic torque wrench to a fastener.

3. The apparatus of claim 1, wherein the applied torque matches the indication torque when the applied torque is within a threshold torque of the indication torque.

4. The apparatus of claim 1, wherein the processing circuitry is further configured to:
determine a time rate of change of the applied torque; and
determine the estimated torque overshoot based on the time rate of change of the applied torque, and the estimated response time.

5. The apparatus of claim 4, wherein the estimated torque overshoot is determined as a product of the time rate of change of the applied torque, and the estimated response time.

6. The apparatus of claim 1, wherein the apparatus further comprises:
a strain gauge assembly configured to measure the applied torque, and produce an analog electrical signal that varies in voltage with the applied torque; and
an analog-to-digital converter configured to convert the analog electrical signal to an equivalent digital electrical signal, and
wherein the processing circuitry is configured to determine the applied torque from the equivalent digital electrical signal.

7. The apparatus of claim 1, wherein the one or more transducers include one or more of an electromechanical transducer configured to convert the output signal to haptic feedback, or an electroacoustic transducer configured to convert the output signal to audible feedback.

8. The apparatus of claim 1, wherein the one or more transducers include one or more electro-optical transducers configured to convert the output signal to visual feedback, and the one or more electro-optical transducers include one or more light emitting diode (LED) indicators.

9. The apparatus of claim 1, wherein the apparatus is operable for an operation to determine the applied torque, and the estimated response time is determined from an actual response time for a previous operation of the apparatus.

10. The apparatus of claim 1, wherein the apparatus is operable for an operation to determine the applied torque, and the processing circuitry is further configured to:
determine an actual response time for the operation as a time between output of the alert and release of the force by the operator; and
determine the estimated response time for a next operation of the apparatus from the actual response time.

11. A method of operating an apparatus to determine an applied torque, the method comprising:
receiving an indication of a target torque;
determining the applied torque;
determining an indication torque that is less than the target torque by an estimated torque overshoot representing an added amount over the applied torque for an estimated response time of an operator;
comparing the applied torque and the indication torque to determine when the applied torque matches the indication torque; and in response,
outputting an alert to the operator to release a force from which the applied torque is produced.

12. The method of claim 11, wherein the apparatus is embodied as an electronic torque wrench, and the applied torque is a torque applied by the electronic torque wrench to a fastener.

13. The method of claim 11, wherein the applied torque matches the indication torque when the applied torque is within a threshold torque of the indication torque.

14. The method of claim 11, wherein the method further comprises:
determining a time rate of change of the applied torque; and
determining the estimated torque overshoot based on the time rate of change of the applied torque, and the estimated response time.

15. The method of claim 14, wherein the estimated torque overshoot is determined as a product of the time rate of change of the applied torque, and the estimated response time.

16. The method of claim 11, wherein determining the applied torque includes:
measuring the applied torque, and producing an analog electrical signal that varies in voltage with the applied torque;
converting the analog electrical signal to an equivalent digital electrical signal; and
determining the applied torque from the equivalent digital electrical signal.

17. The method of claim 11, wherein the alert is output as an output signal, and the method further comprises converting the output signal to user-perceptible feedback by one or more transducers of the apparatus.

18. The method of claim 17, wherein the one or more transducers include one or more of an electromechanical transducer converting the output signal to haptic feedback, or an electroacoustic transducer converting the output signal to audible feedback.

19. The method of claim 17, wherein the one or more transducers include one or more electro-optical transducers converting the output signal to visual feedback, and the one or more electro-optical transducers include one or more light emitting diode (LED) indicators.

20. The method of claim 11, wherein the method is performed for an operation of the apparatus to determine the applied torque, and the estimated response time is determined from an actual response time for a previous operation of the apparatus.

21. The method of claim 11, wherein the method is performed for an operation of the apparatus to determine the applied torque, and the method further comprises:
determining an actual response time for the operation as a time between output of the alert and release of the force by the operator; and
determining the estimated response time for a next operation of the apparatus from the actual response time.
